(19) United States
(12) Patent Application Publication
(10) Pub. No.: US 2026/0212041 A1
(43) Pub. Date: Jul. 23, 2026

(54) DATA QUERY METHOD AND ELECTRONIC DEVICE

(71) Applicant: Tianmian Information Technology (Shenzhen) Co., Ltd., Shenzhen (CN)

(72) Inventors: Huanming Wu, Shenzhen (CN); Wenbin Xu, Shenzhen (CN)

(21) Appl. No.: 19/235,687

(22) Filed: Jun. 12, 2025

(30) Foreign Application Priority Data
Jan. 21, 2025 (CN) 202510099045.7

(51) Int. Cl. G06F 21/62; G06F 21/60; H04L 9/08

(52) U.S. Cl. CPC G06F 21/6245; G06F 21/602; H04L 9/0869

(57) ABSTRACT

The present disclosure discloses a data query method, including: performing random desensitization processing on information to be queried to obtain desensitized query information, and encrypting original text of desensitized content to obtain first encrypted query information; querying a database according to the desensitized query information to acquire corresponding data records, respectively extracting data information corresponding to each data record and encrypting the data information to obtain a first encrypted data record set, and then encrypting the first encrypted query information to obtain second encrypted query information; and encrypting first encrypted data records of the first encrypted data record to obtain a second encrypted data record set, and querying second encrypted query information in the second encrypted data record set to decide whether the information to be queried is in the database. The present disclosure improves the data security of both sides for information exchange in a data query service.

### CROSS REFERENCE TO RELATED APPLICATIONS

The present application claims the benefit of Chinese Patent Application No. 202510099045.7 filed on Jan. 21, 2025, the contents of which are incorporated herein by reference in their entirety.

### TECHNICAL FIELD

The present disclosure relates to the technical field of data processing, and more particularly relates to a data query method and an electronic device.

### BACKGROUND

With the development of the mobile Internet, more and more personal privacy data are collected, transferred, calculated and exchanged to improve the quality of services. At present, for an information exchange service for the personal privacy data, a service supplier generally provides a querier with an interface for querying a list composed of a group of individuals with the same characteristics, such as members and blacklists.

In the prior art, a query interface requires the provision of personal identity information of a queried person, and by taking the blacklist as an example, a common query keyword is a personal identity card number, a mobile phone number, or an international mobile equipment identity (IMEI), and the like. However, in this method, during a query process, the service supplier obtains the personal identity information of the queried person provided by the querier, and even if the queried person is not in the list, the leakage of the personal privacy data of the queried person is caused.

### SUMMARY

The present disclosure provides a data query method and an electronic device, and a main object of the present disclosure is to solve the problem of data leakage in an information exchange service.

In order to achieve the above object, the present disclosure provides a data query method, including the steps of:
performing random desensitization processing on information to be queried to obtain desensitized query information comprising desensitized information and plaintext information, and encrypting original text of the desensitized information by utilizing a first secret key to obtain first encrypted query information;
acquiring a database identifier corresponding to the information to be queried, generating request information according to the desensitized query information, the first encrypted query information and the database identifier, and sending the request information to a data server side;
receiving a first encrypted data record set and second encrypted query information returned by the data server side based on the request information, and respectively encrypting first encrypted data records in the first encrypted data record set by utilizing the first secret key to obtain a second encrypted data record set; and
querying the second encrypted query information in the second encrypted data record set, and deciding whether the information to be queried is in a database corresponding to the database identifier according to a query result.

Optionally, the step of performing random desensitization processing on information to be queried to obtain desensitized query information, includes:
selecting a random number of characters at random positions in the information to be queried according to a preset algorithm; and
performing desensitization processing on the random number of characters at the random positions to obtain the desensitized query information.

Optionally, the step of deciding whether the information to be queried is in a database corresponding to the database identifier according to a query result, includes:
if second encrypted data information which is the same as the second encrypted query information is queried in the second encrypted data record set, deciding that the information to be queried is in the database corresponding to the database identifier; and
if the second encrypted data information which is the same as the second encrypted query information is not queried in the second encrypted data record set, deciding that the information to be queried is not in the database corresponding to the database identifier.

Optionally, the data query method further includes the steps of:
receiving request information sent by the data query side, parsing the request information to obtain desensitized query information, first encrypted query information and a database identifier, and querying a database corresponding to the database identifier according to the desensitized query information to acquire a corresponding data record set;
respectively extracting data information corresponding to each data record in the data record set according to desensitized information of the desensitized query information, respectively encrypting each piece of data information by utilizing a second secret key to obtain a first encrypted data record set, and encrypting the first encrypted query information by utilizing the second secret key to obtain second encrypted query information; and
sending the first encrypted data record set and the second encrypted query information to the data query side.

Optionally, the step of querying a database corresponding to the database identifier according to the desensitized query information to acquire a corresponding data record set, includes:
determining a database to be queried according to the database identifier;
traversing and querying the database according to plaintext information of the desensitized query information to obtain matched data records; and
converting the matched data records into a data format corresponding to the desensitized query information, and generating a data record set according to the converted data records.

Optionally, the step of generating a data record set according to the converted data records, includes:
if a number of the converted data records is greater than or equal to a preset threshold, combining the converted data records to generate the data record set; and
if the number of the converted data records is less than the preset threshold, combining the converted data records to generate the data record set, randomly acquiring data records from the database, and then adding the data records to the data record set after performing data format conversion, until the number of the data records in the data record set is equal to the preset threshold.

Optionally, the step of respectively extracting data information corresponding to each data record in the data record set according to desensitized information of the desensitized query information, includes:
extracting a character corresponding to each data record at a same character position according to a character position of the desensitized information in the desensitized query information; and
respectively merging the extracted character for each data record to obtain data information corresponding to each data record.

In order to achieve the above object, the present disclosure further provides an electronic device, including: a memory and a processor, wherein the processor is electrically connected to the memory, the memory has a computer program executable by the at least one processor stored thereon, and the computer program, when executed by the at least one processor, causes the at least one processor to execute the steps of:
performing random desensitization processing on information to be queried to obtain desensitized query information including desensitized information and plaintext information, and encrypting original text of the desensitized information by utilizing a first secret key to obtain first encrypted query information;
acquiring a database identifier corresponding to the information to be queried, generating request information according to the desensitized query information, the first encrypted query information and the database identifier, and sending the request information to a data server side;
receiving a first encrypted data record set and second encrypted query information returned by the data server side based on the request information, and respectively encrypting first encrypted data records in the first encrypted data record set by utilizing the first secret key to obtain a second encrypted data record set; and
querying the second encrypted query information in the second encrypted data record set, and deciding whether the information to be queried is in a database corresponding to the database identifier according to a query result.

Optionally, the step of performing random desensitization processing on information to be queried to obtain desensitized query information, includes:
selecting a random number of characters at random positions in the information to be queried according to a preset algorithm; and
performing desensitization processing on the random number of characters at the random positions to obtain the desensitized query information.

Optionally, the step of deciding whether the information to be queried is in a database corresponding to the database identifier according to a query result, includes:
if second encrypted data information which is the same as the second encrypted query information is queried in the second encrypted data record set, deciding that the information to be queried is in the database corresponding to the database identifier; and
if the second encrypted data information which is the same as the second encrypted query information is not queried in the second encrypted data record set, deciding that the information to be queried is not in the database corresponding to the database identifier.

In order to achieve the above object, the present disclosure further provides an electronic device, including: a memory and a processor, wherein the processor is electrically connected to the memory, the memory has a computer program executable by the at least one processor stored thereon, and the computer program, when executed by the at least one processor, causes the at least one processor to execute the steps of:
receiving request information sent by the data query side, parsing the request information to obtain desensitized query information, first encrypted query information and a database identifier, and querying a database corresponding to the database identifier according to the desensitized query information to acquire a corresponding data record set;
respectively extracting data information corresponding to each data record in the data record set according to desensitized information of the desensitized query information, respectively encrypting each piece of data information by utilizing a second secret key to obtain a first encrypted data record set, and encrypting the first encrypted query information by utilizing the second secret key to obtain second encrypted query information; and
sending the first encrypted data record set and the second encrypted query information to the data query side.

Optionally, the step of querying a database corresponding to the database identifier according to the desensitized query information to acquire a corresponding data record set, includes:
determining a database to be queried according to the database identifier;
traversing and querying the database according to plaintext information of the desensitized query information to obtain matched data records; and
converting the matched data records into a data format corresponding to the desensitized query information, and generating a data record set according to the converted data records.

Optionally, the step of generating a data record set according to the converted data records, includes:
if a number of the converted data records is greater than or equal to a preset threshold, combining the converted data records to generate the data record set; and
if the number of the converted data records is less than the preset threshold, combining the converted data records to generate the data record set, randomly acquiring data records from the database, and then adding the data records to the data record set after performing data format conversion, until the number of the data records in the data record set is equal to the preset threshold.

Optionally, the step of respectively extracting data information corresponding to each data record in the data record set according to desensitized information of the desensitized query information, includes:
extracting a character corresponding to each data record at a same character position according to a character position of the desensitized information in the desensitized query information; and
respectively merging the extracted character for each data record to obtain data information corresponding to each data record.

In the present disclosure, by performing random desensitization processing on information to be queried at a data query side to obtain desensitized query information, the information to be queried is prevented from being leaked to a data server side completely; and plaintext information of the desensitized query information is queried at the data server side to obtain corresponding data records, corresponding character information in the data records is acquired according to desensitized information of the desensitized query information, and exchangeable sequential encryption is performed on the desensitized information and the character information by the data query side and the data server side respectively by adopting different secret keys, so that a data query list is provided to the data query side on the basis of not leaking the data record information at the data server side, and the data security of both sides for information exchange in a data query service is improved.

### RIEF DESCRIPTION OF THE ACCOMPANYING DRAWINGS

FIG. 1 is a schematic flow diagram of a first example of a data query method according to the present disclosure;

FIG. 2 is a schematic flow diagram of a second example of the data query method according to the present disclosure;

FIG. 3 is a schematic structural diagram of a first example of an electronic device according to the present disclosure;

FIG. 4 is a schematic structural diagram of a second example of the electronic device according to the present disclosure;

FIG. 5 is a schematic diagram of functional modules at a data query side according to the present disclosure; and

FIG. 6 is a schematic diagram of functional modules at a data server side according to the present disclosure.

The achieved objects, functional features and advantages of the present disclosure will be further described with reference to the accompanying drawings in conjunction with the examples.

### DETAILED DESCRIPTION OF ILLUSTRATED EMBODIMENTS

In order to enable the objects, technical solutions and advantages of the present disclosure to be clearer, the present disclosure will be further described in detail below in conjunction with the accompanying drawings and the examples. It should be understood that the specific examples described herein are merely illustrative of the present disclosure and are not intended to limit the present disclosure. Based on the examples in the present disclosure, all other examples obtained by those ordinarily skilled in the art without involving any inventive effort fall within the scope of protection of the present disclosure.

It should be noted that the description involving “first”, “second”, and the like in the present disclosure is used for descriptive purposes only and is not to be construed as indicating or implying relative importance or implicitly indicating the number of technical features indicated. Thus, the features defined by “first” and “second” may explicitly or implicitly include at least one of the features. In addition, the technical solutions among various examples may be combined with one another, but it must be based on the fact that the combination can be implemented by those ordinarily skilled in the art, and when the combination of the technical solutions is contradictory or unachievable, it should be considered that such combination of the technical solutions does not exist and is not within the scope of protection claimed by the present disclosure.

An example of the present application provides a data query method. An execution subject of the data query method includes, but is not limited to, at least one of electronic devices, such as a server side and a terminal, which can be configured to execute the method provided in the example of the present application. In other words, the data query method may be executed by software or hardware installed in terminal equipment or server side equipment, and the software may be a block chain platform. The server side includes, but is not limited to: a single server, a server cluster, a cloud server or a cloud server cluster, and the like. The server may be a stand-alone server, and may also be a cloud server providing basic cloud computing services, such as a cloud service, a cloud database, cloud computing, a cloud function, cloud storage, a network service, cloud communication, a middleware service, a domain name service, a security service, a content delivery network (CDN), and a large data and artificial intelligence platform.

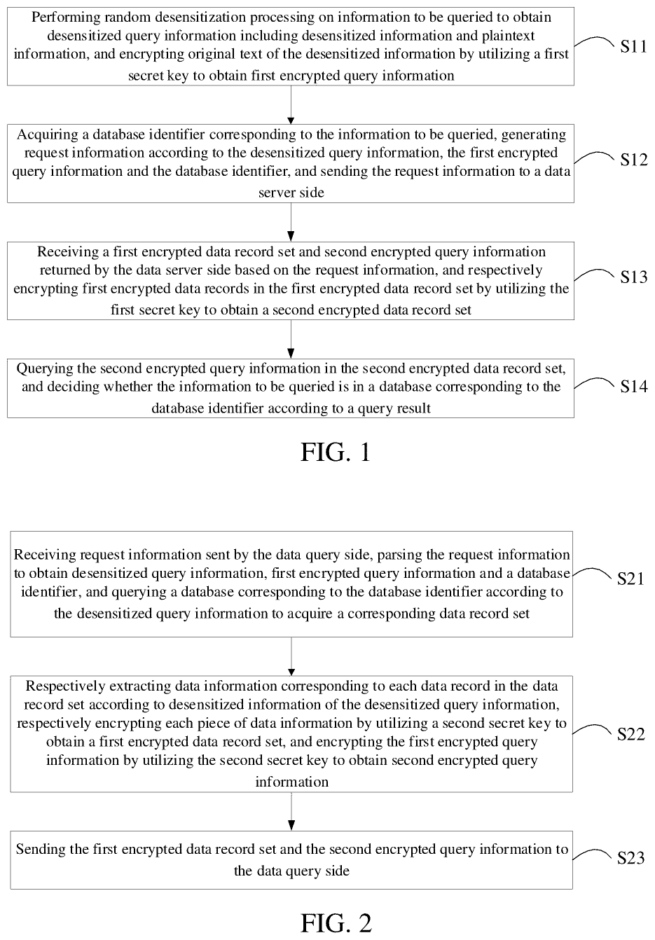

Referring to FIG. 1, FIG. 1 is a schematic flow diagram of a first example of a data query method according to the present disclosure. The data query method is applied to a data query side communicatively connected to a data server side, and includes steps S11 to S14. The data server side and the data query side are electronic devices which can execute a data query program to implement the data query method of the present disclosure.

S11, performing random desensitization processing on information to be queried to obtain desensitized query information including desensitized information and plaintext information, and encrypting original text of the desensitized information by utilizing a first secret key to obtain first encrypted query information.

In one example, before performing random desensitization processing on information to be queried, the data query method further includes:
if the information to be queried includes a plurality of pieces of information, connecting and merging the plurality of pieces of information according to a pre-determined data format.

For example, when the information to be queried includes a plurality of pieces of information, information connection and merging are performed on each piece of information in the information to be queried by taking a symbol “|” as a connection symbol. For example, mobile phone number: 13412345678 (fictitious), identity card number: 110101199003076974 (fictitious), and name: Liu Dehua (fictitious) are connected and merged with the symbol “|” to obtain “13412345678|110101199003076974|Liu Dehua”.

In one example, performing random desensitization processing on information to be queried to obtain desensitized query information includes:
selecting a random number of characters at random positions in the information to be queried according to a preset algorithm; and
performing desensitization processing on the random number of characters at the random positions to obtain the desensitized query information.

Specifically, when the information to be queried is data information containing key characters, the key characters are desensitized together with the random number of characters at the random positions.

For example, when the information to be queried is an 11-bit mobile phone number, the last 4-bit number is the key character, and after the random number of characters at the random positions in the information to be queried are selected according to the preset algorithm, the last 4-bit number is desensitized (for example, replaced with a symbol *) together with the selected character, so as to ensure that key character information is not leaked.

Specifically, if the information to be queried contains a plurality of pieces of information, a random number of characters at random positions are respectively selected for each piece of information by the preset algorithm, so as to ensure that each piece of information contains a character subjected to desensitization processing, and prevent the complete plaintext information from being leaked due to the lack of desensitization processing on a certain piece of information.

For example, random desensitization processing is performed on the information to be queried “13412345678|110101199003076974|Liu Dehua”, a random number of characters at random positions are respectively selected for three pieces of information connected by the symbol “|” according to the preset algorithm, and the selected characters are desensitized (for example, replaced with the symbol *) to obtain desensitized query information “1341234****|110101****03076**4|Liu *hua”, wherein the symbol * is used for representing the desensitized information, and the content “5678199097 De” desensitized and replaced with the symbol * is original text corresponding to the desensitized information, and the remaining content which is not desensitized is plaintext information.

In one example, the first secret key is a secret key generated by utilizing an exchangeable encryption algorithm. The original text of the desensitized information is encrypted by utilizing the first secret key to obtain first ciphertext corresponding to the desensitized information. For example, the original text of the desensitized information of the desensitized query information “1341234****|110101****03076**4|Liu *hua” is “5678199097 De”, the original text of the desensitized information “5678199097 De” is encrypted by utilizing the first secret key K_{A} generated by the exchangeable encryption algorithm to obtain the first ciphertext K_{A} “5678199097 De” corresponding to the desensitized information as the first encrypted query information.

S12, acquiring a database identifier corresponding to the information to be queried, generating request information according to the desensitized query information, the first encrypted query information and the database identifier, and sending the request information to a data server side.

In one example, acquiring a database identifier corresponding to the information to be queried includes:
determining a target database in which the information to be queried requires to be queried, and acquiring a database identifier corresponding to the target database.

Specifically, the request information includes query request information for querying data records matching the plaintext information of the desensitized query information in the database corresponding to the database identifier, and encryption request information for encrypting the first encrypted query information.

S13, receiving a first encrypted data record set and second encrypted query information returned by the data server side based on the request information, and respectively encrypting first encrypted data records in the first encrypted data record set by utilizing the first secret key to obtain a second encrypted data record set.

In one example, the data records matching the plaintext information of the desensitized query information are queried in the database corresponding to the database identifier by the data server side based on the query request information in the request information, and the data records are extracted and encrypted according to the desensitized information of the desensitized query information to obtain the first encrypted data record set.

In one example, the first encrypted query information is encrypted by the data server side by adopting a second secret key generated by the exchangeable encryption algorithm based on the encryption request information in the request information to obtain the second encrypted query information.

In this example, a plurality of same data records matching the plaintext information are queried by the data server side according to the information to be queried, corresponding data information in the data records is extracted according to a position of the desensitized information in the information to be queried to form a data record set, and if the information to be queried is in the queried data records, the data record set contains data information which is the same as the original text of the desensitized information in the information to be queried.

Specifically, first encryption is performed on the original text of the desensitized information in the information to be queried by the data query side through the first secret key to obtain the first ciphertext corresponding to the original text of the desensitized information, namely, the first encrypted query information, and then second encryption is performed on the first encrypted query information by the data server side through the second secret key to obtain second ciphertext after re-encryption of the first ciphertext corresponding to the original text of the desensitized information. First encryption is respectively performed on each piece of data information in the data record set by the data server side through the second secret key to obtain a second ciphertext set corresponding to the data information, namely, the first encrypted data record set, and then second encryption is respectively performed on the first encrypted data information in the first encrypted data record set by the data query side through the first secret key to obtain a first ciphertext set after re-encryption of the second ciphertext corresponding to the data information, namely, the second encrypted data record set.

In this example, the original text of the desensitized information in the information to be queried and the data information extracted based on the desensitized information in the data records queried based on the plaintext information are sequentially encrypted by the data query side and the data server side by utilizing the secret keys generated by the exchangeable encryption algorithm, the same data is sequentially encrypted by the algorithm by using different secret keys, and the obtained result is independent from an encryption order, namely, the ciphertext after secondary encryption which is obtained by firstly using the first secret key to encrypt data and then using the second secret key to encrypt data, or firstly using the second secret key to encrypt the same data and then using the first secret key to encrypt the same data is consistent.

For example, the first encrypted data record set includes 10 pieces of first encrypted data information {K_{B} (23459997 Xian), K_{B} (56789069 De), K_{B} (12345678 Hua), K_{B} (23456789 Sheng), K_{B} (34567890 Wen), K_{B} (45678901 Fang), K_{B} (67890123 Jiu), K_{B} (78901234 Ying), K_{B} (89012345 Sheng), and K_{B} (90123456 Pai)}, secondary encryption is respectively performed on each piece of first encrypted data information by utilizing the first secret key, and the obtained second encrypted data record set includes 10 pieces of second encrypted data information {K_{A} (K_{B} (23459997 Xian)), K_{A} (K_{B} (56789069 De)), K_{A} (K_{B} (12345678 Hua)), K_{A} (K_{B} (23456789 Sheng)), K_{A} (K_{B} (34567890 Wen)), K_{A} (K_{B} (45678901 Fang)), K_{A} (K_{B} (67890123 Jiu)), K_{A} (K_{B} (78901234 Ying)), K_{A} (K_{B} (89012345 Sheng)), and K_{A} (K_{B} (90123456 Pai))}.

S14, querying the second encrypted query information in the second encrypted data record set, and deciding whether the information to be queried is in a database corresponding to the database identifier according to a query result.

In one example, deciding whether the information to be queried is in the target database according to the query result includes:
if second encrypted data information which is the same as the second encrypted query information is queried in the second encrypted data record set, deciding that the information to be queried is in the database corresponding to the database identifier; and
if the second encrypted data information which is the same as the second encrypted query information is not queried in the second encrypted data record set, deciding that the information to be queried is not in the database corresponding to the database identifier.

In this example, the second encrypted query information is obtained by firstly encrypting the desensitized information of the information to be queried with the first secret key and then encrypting the desensitized information with the second secret key, and the second encrypted data information in the second encrypted data record set is obtained by firstly encrypting the desensitized information of the data records with the second secret key and then encrypting the desensitized information with the first secret key. Since the first secret key and the second secret key are both secret keys generated by the exchangeable algorithm, even if the encryption orders are different, the finally obtained encrypted data is consistent, querying whether the second encrypted data information which is the same as the second encrypted query information is present in the second encrypted data record set may confirm whether the information to be queried is in the database corresponding to the database identifier.

In the example of the present disclosure, by performing random desensitization processing on information to be queried at a data query side to obtain desensitized query information, the information to be queried is prevented from being leaked to a data server side completely; and exchangeable sequential encryption is performed on the desensitized information and the character information by the data query side and the data server side respectively by adopting different secret keys, so that a data query list is provided to the data query side on the basis of not leaking the data record information at the data server side, and the data security of both sides for information exchange in a data query service is improved.

Referring to FIG. 2, FIG. 2 is a schematic flow diagram of a second example of the data query method according to the present disclosure. The data query method is applied to a data server side communicatively connected to a data query side, and includes steps S21 to S23.

S21, receiving request information sent by the data query side, parsing the request information to obtain desensitized query information, first encrypted query information and a database identifier, and querying a database corresponding to the database identifier according to the desensitized query information to acquire a corresponding data record set.

In one example, querying a database corresponding to the database identifier according to the desensitized query information to acquire a corresponding data record set includes:

### Determining a Database to Be Queried According to the Database Identifier;

traversing and querying the database according to plaintext information of the desensitized query information to obtain matched data records; and

converting the matched data records into a data format corresponding to the desensitized query information, and generating a data record set according to the converted data records.

For example, the database to be queried is determined to be a blacklist library by the data server side according to the database identifier, two data records {mobile phone number: 13412342345, identity card number: 110101199903079774, and name: Liu Xianhua; mobile phone number: 13412345678, identity card number: 110101199003076974, and name: Liu Dehua} satisfying the plaintext information are queried in the blacklist library according to the desensitized query information “1341234****|110101****03076**4|Liu *hua”, and the data records are converted into the data format corresponding to the desensitized query information to obtain one data record set {13412342345|110101199903079774|Liu Xianhua, 13412345678|110101199003076974|Liu Dehua}.

In one example, generating a data record set according to the converted data records includes:
if a number of the converted data records is greater than or equal to a preset threshold, combining the converted data records to generate the data record set; and
if the number of the converted data records is less than the preset threshold, combining the converted data records to generate the data record set, randomly acquiring data records from the database, and then adding the data records to the data record set after performing data format conversion, until the number of the data records in the data record set is equal to the preset threshold.

In this example, if the number of the data records in the finally obtained data record set is too small, it is easy to disclose some features about the data record set, thereby resulting in information leakage at the data server side, and therefore randomly acquiring the data records from the database for supplementation can prevent the data features at the data server side from being leaked on the basis of not affecting the query result.

S22, respectively extracting data information corresponding to each data record in the data record set according to desensitized information of the desensitized query information, respectively encrypting each piece of data information by utilizing a second secret key to obtain a first encrypted data record set, and encrypting the first encrypted query information by utilizing the second secret key to obtain second encrypted query information.

In one example, respectively extracting data information corresponding to each data record in the data record set according to desensitized information of the desensitized query information, includes:
extracting a character corresponding to each data record in the data record set at a same character position according to a character position of the desensitized information in the desensitized query information; and
respectively merging the extracted character for each data record to obtain data information corresponding to each data record.

For example, the character corresponding to each data record in the data record set at the same character position is extracted according to the character position of the desensitized information in the desensitized query information “1341234****|110101****03076**4|Liu *hua” and the characters are merged to obtain the data set: {23459997 Xian, 56789069 De, 12345678 Hua, 23456789 Sheng, 34567890 Wen, 45678901 Fang, 67890123 Jiu, 78901234 Ying, 89012345 Sheng, and 90123456 Pai}.

Specifically, the second secret key is a secret key generated by the exchangeable algorithm. Each piece of data information is respectively encrypted by utilizing the second secret key to obtain second ciphertext corresponding to each piece of data information. For example, each piece of data information in the data set {23459997 Xian, 56789069 De, 12345678 Hua, 23456789 Sheng, 34567890 Wen, 45678901 Fang, 67890123 Jiu, 78901234 Ying, 89012345 Sheng, and 90123456 Pai} is respectively encrypted by utilizing the second secret key K_{B} generated by the exchangeable encryption algorithm to obtain the first encrypted data record set {K_{B} (23459997 Xian), K_{B} (56789069 De), K_{B} (12345678 Hua), K_{B} (23456789 Sheng), K_{B} (34567890 Wen), K_{B} (45678901 Fang), K_{B} (67890123 Jiu), K_{B} (78901234 Ying), K_{B} (89012345 Sheng), and K_{B} (90123456 Pai)}.

Specifically, secondary encryption is performed on the first encrypted query information by utilizing the second secret key to obtain the second encrypted query information. For example, secondary encryption is performed on the first encrypted query information K_{A} (5678199097 De) by utilizing the second secret key K_{B} generated by the exchangeable encryption algorithm to obtain the second encrypted query information K_{B} (K_{A} (5678199097 De)).

S23, sending the first encrypted data record set and the second encrypted query information to the data query side.

In the example of the present disclosure, plaintext information of the desensitized query information is queried at the data server side to obtain corresponding data records, corresponding character information in the data records is acquired according to desensitized information of the desensitized query information, and exchangeable sequential encryption is performed on the desensitized information and the character information by the data query side and the data server side respectively by adopting different secret keys, so that a data query list is provided to the data query side on the basis of not leaking the data record information at the data server side, and the data security of both sides for information exchange in a data query service is improved.

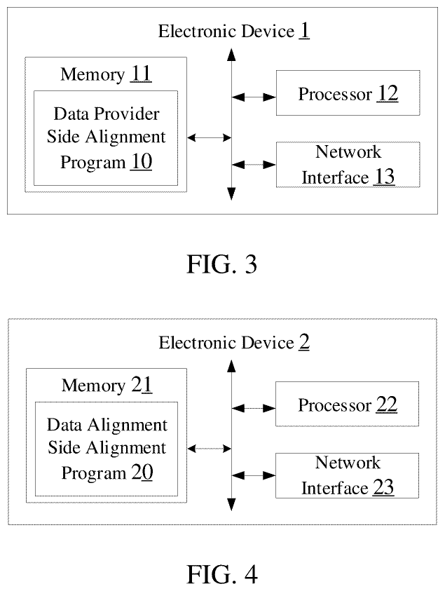

Referring to FIG. 3, FIG. 3 is a schematic structural diagram of a first example of an electronic device according to the present disclosure. The electronic device 1 is equipment capable of automatically performing numerical calculation and/or information processing according to preset or stored instructions. The electronic device 1 may be a computer, a single network server, a server group consisting of a plurality of network servers, or cloud based on cloud computing composed of a large number of hosts or network servers, wherein the cloud computing is one type of distributed computing, which is a super virtual computer consisting of a group of loosely coupled computer sets.

In this example, the electronic device 1 includes, but is not limited to, a memory 11, a processor 12, and a network interface 13 which may be communicatively connected to one another through system buses, wherein the memory 11 has a data query program 10 stored therein, and the data query program 10 may be executed by the processor 12. FIG. 3 only shows the electronic device 1 having components 11 to 13 and the data query program 10, and it will be understood by those skilled in the art that a structure shown in FIG. 3 does not constitute limitation on the electronic device 1 which may include fewer or more components than those shown, or a combination of some components, or different arrangement of components.

Wherein the memory 11 includes an internal memory and at least one type of readable storage medium. The internal memory provides a cache for running of the electronic device 1; and the readable storage medium may be volatile or non-volatile. Specifically, the readable storage medium may be a storage medium such as a flash memory, a hard disk, a multi-media card, a card-type memory (such as an SD or DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. In some examples, the readable storage medium may be an internal storage unit of the electronic device 1, such as a hard disk of the electronic device 1; and in other examples, the storage medium may also be external storage equipment of the electronic device 1, such as a plug-in hard disk, a smart media card (SMC), a secure digital (SD) card, a flash card, and the like equipped on the electronic device 1. In this example, the readable storage medium of the memory 11 mainly includes a program storage area and a data storage area, wherein the program storage area is generally used for storing an operating system and various application software installed on the electronic device 1, for example, storing codes of the data query program 10 in one example of the present disclosure, and the like; and the data storage area may store data created according to the use of a block chain node, and the like, such as various types of data which have been output or are to be output.

In some examples, the processor 12 may be a central processing unit (CPU), a controller, a microcontroller, a microprocessor, or other data processing chips. The processor 12 is generally used for controlling the overall operation of the electronic device 1, such as executing the control and processing related to data interaction or communication with other equipment, and the like. In this example, the processor 12 is used for running program codes stored in the memory 11 or processing data, for example, running the data query program 10, and the like.

The network interface 13 may include a wireless network interface or a wired network interface, and the network interface 13 is used for establishing communicative connection between the electronic device 1 and a client side (not shown in the drawings).

Optionally, the electronic device 1 may further include a user interface, the user interface may include a display, and an input unit such as a keyboard, and optionally the user interface may further include a standard wired interface and wireless interface. Optionally, in some examples, the display may be an LED display, a liquid crystal display, a touch-sensitive liquid crystal display, an organic light-emitting diode (OLED) touch-sensitive display, and the like, wherein the display may also be suitably referred to as a display screen or display unit for displaying information processed in the electronic device 1 and for displaying a visual user interface.

In one example of the present disclosure, the data query program 10, when executed by the processor 12, implements the steps of S11 to S14:
S11, performing random desensitization processing on information to be queried to obtain desensitized query information including desensitized information and plaintext information, and encrypting original text of the desensitized information by utilizing a first secret key to obtain first encrypted query information;
S12, acquiring a database identifier corresponding to the information to be queried, generating request information according to the desensitized query information, the first encrypted query information and the database identifier, and sending the request information to a data server side;
S13, receiving a first encrypted data record set and second encrypted query information returned by the data server side based on the request information, and respectively encrypting first encrypted data records in the first encrypted data record set by utilizing the first secret key to obtain a second encrypted data record set; and
S14, querying the second encrypted query information in the second encrypted data record set, and deciding whether the information to be queried is in a database corresponding to the database identifier according to a query result.

The specific operation steps implemented by the above steps S11 to S14 are substantially the same as those of the first example of the data query method according to the present disclosure, which will not be described in detail herein.

In other examples, the data query program 10 may be segmented into one or more modules, and the one or more modules are stored in the memory 11 and executed by one or more processors (the processor 12 in this example) to achieve the present disclosure. The module in the present disclosure refers to a series of computer program instruction segments capable of achieving a particular function for describing an execution process of the data query program 10 in the electronic device 1.

Referring to FIG. 4, FIG. 4 is a schematic structural diagram of a second example of the electronic device according to the present disclosure. The electronic device 2 is equipment capable of automatically performing numerical calculation and/or information processing according to preset or stored instructions. The electronic device 2 may be a computer, a single network server, a server group consisting of a plurality of network servers, or cloud based on cloud computing composed of a large number of hosts or network servers, wherein the cloud computing is one type of distributed computing, which is a super virtual computer consisting of a group of loosely coupled computer sets.

In this example, the electronic device 2 includes, but is not limited to, a memory 21, a processor 22, and a network interface 23 which may be communicatively connected to one another through system buses, wherein the memory 21 has a data query program 20 stored therein, and the data query program 20 may be executed by the processor 22. FIG. 4 only shows the electronic device 2 having components 21 to 23 and the data query program 20, and it will be understood by those skilled in the art that a structure shown in FIG. 4 does not constitute limitation on the electronic device 2 which may include fewer or more components than those shown, or a combination of some components, or different arrangement of components.

Wherein the memory 21 includes an internal memory and at least one type of readable storage medium. The internal memory provides a cache for running of the electronic device 2; and the readable storage medium may be volatile or non-volatile. Specifically, the readable storage medium may be a storage medium such as a flash memory, a hard disk, a multi-media card, a card-type memory (such as an SD or DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. In some examples, the readable storage medium may be an internal storage unit of the electronic device 2, such as a hard disk of the electronic device 2; and in other examples, the storage medium may also be external storage equipment of the electronic device 2, such as a plug-in hard disk, a smart media card (SMC), a secure digital (SD) card, a flash card, and the like equipped on the electronic device 2. In this example, the readable storage medium of the memory 21 mainly includes a program storage area and a data storage area, wherein the program storage area is generally used for storing an operating system and various application software installed on the electronic device 2, for example, storing codes of the data query program 20 in one example of the present disclosure, and the like; and the data storage area may store data created according to the use of a block chain node, and the like, such as various types of data which have been output or are to be output.

In some examples, the processor 22 may be a central processing unit (CPU), a controller, a microcontroller, a microprocessor, or other data processing chips. The processor 22 is generally used for controlling the overall operation of the electronic device 2, such as executing the control and processing related to data interaction or communication with other equipment, and the like. In this example, the processor 22 is used for running program codes stored in the memory 21 or processing data, for example, running the data query program 20, and the like.

The network interface 23 may include a wireless network interface or a wired network interface, and the network interface 23 is used for establishing communicative connection between the electronic device 2 and a client side (not shown in the drawings).

Optionally, the electronic device 2 may further include a user interface, the user interface may include a display, and an input unit such as a keyboard, and optionally the user interface may further include a standard wired interface and wireless interface. Optionally, in some examples, the display may be an LED display, a liquid crystal display, a touch-sensitive liquid crystal display, an organic light-emitting diode (OLED) touch-sensitive display, and the like, wherein the display may also be suitably referred to as a display screen or display unit for displaying information processed in the electronic device 2 and for displaying a visual user interface.

In one example of the present disclosure, the data query program 20, when executed by the processor 22, implements the steps of S21 to S23:
S21, receiving request information sent by the data query side, parsing the request information to obtain desensitized query information, first encrypted query information and a database identifier, and querying a database corresponding to the database identifier according to the desensitized query information to acquire a corresponding data record set;
S22, respectively extracting data information corresponding to each data record in the data record set according to desensitized information of the desensitized query information, respectively encrypting each piece of data information by utilizing a second secret key to obtain a first encrypted data record set, and encrypting the first encrypted query information by utilizing the second secret key to obtain second encrypted query information; and
S23, sending the first encrypted data record set and the second encrypted query information to the data query side.

The specific operation steps implemented by the above steps S21 to S23 are substantially the same as those of the second example of the data query method according to the present disclosure, which will not be described in detail herein.

In other examples, the data query program 20 may be segmented into one or more modules, and the one or more modules are stored in the memory 21 and executed by one or more processors (the processor 22 in this example) to achieve the present disclosure. The module in the present disclosure refers to a series of computer program instruction segments capable of achieving a particular function for describing an execution process of the data query program 20 in the electronic device 2.

It can be seen from the above examples that for the electronic devices 1 and 2 provided in the present disclosure, by performing random desensitization processing on information to be queried at a data query side to obtain desensitized query information, the information to be queried is prevented from being leaked to a data server side completely; and plaintext information of the desensitized query information is queried at the data server side to obtain corresponding data records, corresponding character information in the data records is acquired according to desensitized information of the desensitized query information, and exchangeable sequential encryption is performed on the desensitized information and the character information by the data query side and the data server side respectively by adopting different secret keys, so that a data query list is provided to the data query side on the basis of not leaking the data record information at the data server side, and the data security of both sides for information exchange in a data query service is improved.

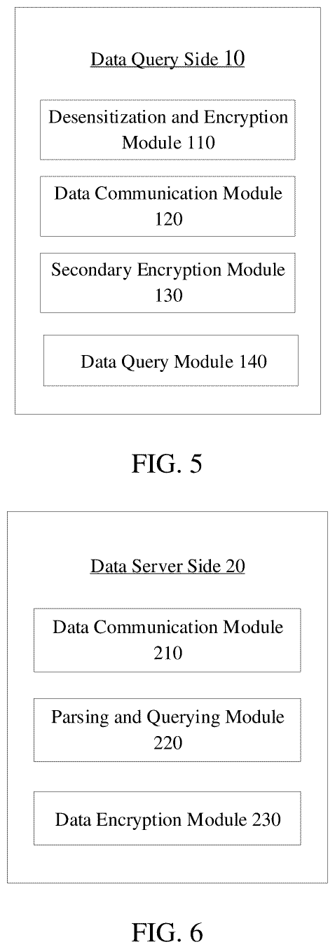

Referring to FIG. 5, FIG. 5 is a schematic diagram of functional modules at a data query side according to the present disclosure. The data query side 10 includes a desensitization and encryption module 110, a data communication module 120, a secondary encryption module 130, and a data query module 140, illustratively:
the desensitization and encryption module 110 is configured for performing random desensitization processing on information to be queried to obtain desensitized query information including desensitized information and plaintext information, and encrypting original text of the desensitized information by utilizing a first secret key to obtain first encrypted query information;
the data communication module 120 is configured for acquiring a database identifier corresponding to the information to be queried, generating request information according to the desensitized query information, the first encrypted query information and the database identifier, sending the request information to a data server side, and receiving a first encrypted data record set and second encrypted query information returned by the data server side based on the request information;
the secondary encryption module 130 is configured for respectively encrypting first encrypted data records in the first encrypted data record set by utilizing the first secret key to obtain a second encrypted data record set; and
the data query module 140 is configured for querying the second encrypted query information in the second encrypted data record set, and deciding whether the information to be queried is in a database corresponding to the database identifier according to a query result.

The specific operation steps implemented when the desensitization and encryption module 110, the data communication module 120, the secondary encryption module 130, and the data query module 140 described above are executed are substantially the same as those of the above examples, which will not be described in detail herein.

Referring to FIG. 6, FIG. 6 is a schematic diagram of functional modules at a data server side according to the present disclosure. The data server side 20 includes a data communication module 210, a parsing and querying module 220, and a data encryption module 230, illustratively:
the data communication module 210 is configured for receiving request information sent by the data query side, and sending a first encrypted data record set and second encrypted query information to the data query side;
the parsing and querying module 220 is configured for parsing the request information to obtain desensitized query information, first encrypted query information and a database identifier, and querying a database corresponding to the database identifier according to the desensitized query information to acquire a corresponding data record set; and
the data encryption module 230 is configured for respectively extracting data information corresponding to each data record in the data record set according to desensitized information of the desensitized query information, respectively encrypting each piece of data information by utilizing a second secret key to obtain the first encrypted data record set, and encrypting the first encrypted query information by utilizing the second secret key to obtain the second encrypted query information.

The specific operation steps implemented when the data communication module 210, the parsing and querying module 220, and the data encryption module 230 described above are executed are substantially the same as those of the above examples, which will not be described in detail herein.

In addition, an example of the present disclosure further provides a computer-readable storage medium which may be volatile or non-volatile. Specifically, the computer-readable storage medium may be any one or any combination of some of a hard disk, a multi-media card, an SD card, a flash memory card, an SMC, a read-only memory (ROM), an erasable programmable read-only memory (EPROM), a portable compact disc read-only memory (CD-ROM), a USB memory, and the like. A data query program 10 applied to the data query side and a data query program 20 applied to the data server side are stored in the computer-readable storage medium.

The data query program 10, when executed by a processor, implements the operation of:
A11, performing random desensitization processing on information to be queried to obtain desensitized query information including desensitized information and plaintext information, and encrypting original text of the desensitized information by utilizing a first secret key to obtain first encrypted query information;
A12, acquiring a database identifier corresponding to the information to be queried, generating request information according to the desensitized query information, the first encrypted query information and the database identifier, and sending the request information to a data server side;
A13, receiving a first encrypted data record set and second encrypted query information returned by the data server side based on the request information, and respectively encrypting first encrypted data records in the first encrypted data record set by utilizing the first secret key to obtain a second encrypted data record set; and
A14, querying the second encrypted query information in the second encrypted data record set, and deciding whether the information to be queried is in a database corresponding to the database identifier according to a query result.

The data query program 20, when executed by the processor, implements the operation of:
A21, receiving request information sent by the data query side, parsing the request information to obtain desensitized query information, first encrypted query information and a database identifier, and querying a database corresponding to the database identifier according to the desensitized query information to acquire a corresponding data record set;
A22, respectively extracting data information corresponding to each data record in the data record set according to desensitized information of the desensitized query information, respectively encrypting each piece of data information by utilizing a second secret key to obtain a first encrypted data record set, and encrypting the first encrypted query information by utilizing the second secret key to obtain second encrypted query information; and
A23, sending the first encrypted data record set and the second encrypted query information to the data query side.

The above serial numbers of the examples of the present disclosure are merely used for the purpose of description and do not represent the advantages and disadvantages of the examples.

It should be noted that, as used herein, the terms “including”, “containing”, or any other variations thereof, are intended to cover a non-exclusive inclusion, so that a process, device, article, or method including a series of elements does not include only those elements but may further include other elements not expressly listed or inherent to such process, device, article, or method. An element proceeded by the phrase “including one...” does not, without more constraints, preclude the existence of additional identical elements in the process, device, article, or method including the element.

Through the description of the above embodiments, it will be clear to those skilled in the art that the methods in the examples described above may be implemented by means of software and an essential general-purpose hardware platform, and of course may also be implemented by means of hardware, but in many cases the former is a preferred embodiment. Based on such understanding, the technical solution of the present disclosure, in essence or in part contributing to the prior art, may be embodied in the form of a software product, and this computer software product is stored in one storage medium (such as an ROM/RAM, a magnetic diskette, and an optical disk), and includes a plurality of instructions for causing one terminal equipment (which may be a mobile phone, a computer, a server, an air conditioner, or a network equipment, and the like) to execute the methods according to various examples of the present disclosure.

The foregoing is merely preferred examples of the present disclosure and does not limit the patent scope of the present disclosure. Any equivalent structure or equivalent flow transformation made by utilizing the content of the specification and accompanying drawings of the present disclosure, or direct or indirect application in other related technical fields, is equally included in the scope of patent protection of the present disclosure.

What is claimed is:

1. A data query method, comprising the steps of:
performing random desensitization processing on information to be queried to obtain desensitized query information comprising desensitized information and plaintext information, and encrypting original text of the desensitized information by utilizing a first secret key to obtain first encrypted query information;
acquiring a database identifier corresponding to the information to be queried, generating request information according to the desensitized query information, the first encrypted query information and the database identifier, and sending the request information to a data server side;
receiving a first encrypted data record set and second encrypted query information returned by the data server side based on the request information, and respectively encrypting first encrypted data records in the first encrypted data record set by utilizing the first secret key to obtain a second encrypted data record set; and
querying the second encrypted query information in the second encrypted data record set, and deciding whether the information to be queried is in a database corresponding to the database identifier according to a query result.

2. The data query method of claim 1, wherein the step of performing random desensitization processing on information to be queried to obtain desensitized query information, comprises:
selecting a random number of characters at random positions in the information to be queried according to a preset algorithm; and
performing desensitization processing on the random number of characters at the random positions to obtain the desensitized query information.

3. The data query method of claim 1, wherein the step of deciding whether the information to be queried is in a database corresponding to the database identifier according to a query result, comprises:
if second encrypted data information which is the same as the second encrypted query information is queried in the second encrypted data record set, deciding that the information to be queried is in the database corresponding to the database identifier; and
if the second encrypted data information which is the same as the second encrypted query information is not queried in the second encrypted data record set, deciding that the information to be queried is not in the database corresponding to the database identifier.

4. The data query method of claim 1, wherein the data query method further comprises the steps of:
receiving request information sent by the data query side, parsing the request information to obtain desensitized query information, first encrypted query information and a database identifier, and querying a database corresponding to the database identifier according to the desensitized query information to acquire a corresponding data record set;
respectively extracting data information corresponding to each data record in the data record set according to desensitized information of the desensitized query information, respectively encrypting each piece of data information by utilizing a second secret key to obtain a first encrypted data record set, and encrypting the first encrypted query information by utilizing the second secret key to obtain second encrypted query information; and
sending the first encrypted data record set and the second encrypted query information to the data query side.

5. The data query method of claim 4, wherein the step of querying a database corresponding to the database identifier according to the desensitized query information to acquire a corresponding data record set, comprises:
determining a database to be queried according to the database identifier;
traversing and querying the database according to plaintext information of the desensitized query information to obtain matched data records; and
converting the matched data records into a data format corresponding to the desensitized query information, and generating a data record set according to the converted data records.

6. The data query method of claim 5, wherein the step of generating a data record set according to the converted data records, comprises:
if a number of the converted data records is greater than or equal to a preset threshold, combining the converted data records to generate the data record set; and
if the number of the converted data records is less than the preset threshold, combining the converted data records to generate the data record set, randomly acquiring data records from the database, and then adding the data records to the data record set after performing data format conversion, until the number of the data records in the data record set is equal to the preset threshold.

7. The data query method of claim 4, wherein the step of respectively extracting data information corresponding to each data record in the data record set according to desensitized information of the desensitized query information, comprises:
extracting a character corresponding to each data record at a same character position according to a character position of the desensitized information in the desensitized query information; and
respectively merging the extracted character for each data record to obtain data information corresponding to each data record.

8. An electronic device, comprising: a memory and a processor, wherein the processor is electrically connected to the memory, the memory has a computer program executable by the at least one processor stored thereon, and the computer program, when executed by the at least one processor, causes the at least one processor to execute the steps of:
performing random desensitization processing on information to be queried to obtain desensitized query information comprising desensitized information and plaintext information, and encrypting original text of the desensitized information by utilizing a first secret key to obtain first encrypted query information;
acquiring a database identifier corresponding to the information to be queried, generating request information according to the desensitized query information, the first encrypted query information and the database identifier, and sending the request information to a data server side;
receiving a first encrypted data record set and second encrypted query information returned by the data server side based on the request information, and respectively encrypting first encrypted data records in the first encrypted data record set by utilizing the first secret key to obtain a second encrypted data record set; and
querying the second encrypted query information in the second encrypted data record set, and deciding whether the information to be queried is in a database corresponding to the database identifier according to a query result.

9. The electronic device of claim 8, wherein the step of performing random desensitization processing on information to be queried to obtain desensitized query information, comprises:
selecting a random number of characters at random positions in the information to be queried according to a preset algorithm; and
performing desensitization processing on the random number of characters at the random positions to obtain the desensitized query information.

10. The electronic device of claim 8, wherein the step of deciding whether the information to be queried is in a database corresponding to the database identifier according to a query result, comprises:
if second encrypted data information which is the same as the second encrypted query information is queried in the second encrypted data record set, deciding that the information to be queried is in the database corresponding to the database identifier; and
if the second encrypted data information which is the same as the second encrypted query information is not queried in the second encrypted data record set, deciding that the information to be queried is not in the database corresponding to the database identifier.

11. An electronic device, comprising: a memory and a processor, wherein the processor is electrically connected to the memory, the memory has a computer program executable by the at least one processor stored thereon, and the computer program, when executed by the at least one processor, causes the at least one processor to execute the steps of:
receiving request information sent by the data query side, parsing the request information to obtain desensitized query information, first encrypted query information and a database identifier, and querying a database corresponding to the database identifier according to the desensitized query information to acquire a corresponding data record set;
respectively extracting data information corresponding to each data record in the data record set according to desensitized information of the desensitized query information, respectively encrypting each piece of data information by utilizing a second secret key to obtain a first encrypted data record set, and encrypting the first encrypted query information by utilizing the second secret key to obtain second encrypted query information; and
sending the first encrypted data record set and the second encrypted query information to the data query side.

12. The electronic device of claim 11, wherein the step of querying a database corresponding to the database identifier according to the desensitized query information to acquire a corresponding data record set, comprises:
determining a database to be queried according to the database identifier;
traversing and querying the database according to plaintext information of the desensitized query information to obtain matched data records; and
converting the matched data records into a data format corresponding to the desensitized query information, and generating a data record set according to the converted data records.

13. The electronic device of claim 12, wherein the step of generating a data record set according to the converted data records, comprises:
if a number of the converted data records is greater than or equal to a preset threshold, combining the converted data records to generate the data record set; and
if the number of the converted data records is less than the preset threshold, combining the converted data records to generate the data record set, randomly acquiring data records from the database, and then adding the data records to the data record set after performing data format conversion, until the number of the data records in the data record set is equal to the preset threshold.

14. The electronic device of claim 11, wherein the step of respectively extracting data information corresponding to each data record in the data record set according to desensitized information of the desensitized query information, comprises:
extracting a character corresponding to each data record at a same character position according to a character position of the desensitized information in the desensitized query information; and
respectively merging the extracted character for each data record to obtain data information corresponding to each data record.
